(19) United States
(12) Patent Application Publication
(10) Pub. No.: US 2026/0359810 A1
(43) Pub. Date: Nov. 12, 2026

(54) AGENT PLATFORM FOR COMMERCIAL TRANSACTIONS AND COMPUTER-IMPLEMENTED AGENT METHODS WITH PAYMENT FUNCTIONALITY

(71) Applicant: Supertab AG, Steinhausen (CH)

(72) Inventors: Cosmin-Gabriel Ene, Zollikon (CH); Jesse Knight, Scarborough, ME (US)

(21) Appl. No.: 19/672,205

(22) Filed: May 8, 2026

Related U.S. Application Data
(60) Provisional application No. 63/865,886, filed on Aug. 18, 2025.

(30) Foreign Application Priority Data
May 9, 2025 (IE) S2025/0205

(51) Int. Cl. G06Q 20/38

(52) U.S. Cl. CPC G06Q 20/38

(57) ABSTRACT

Distributed autonomous transaction platform includes a processing unit adapted to provide: (a) a transaction orchestration engine configured to generate machine-readable transaction objects representing autonomous commercial intents associated with a request by a consumer; (b) a routing engine configured to select at least one of a plurality of autonomous service agents based on trust scores, pricing conditions, computational efficiency, and/or policy constraints, and route the machine-readable transaction objects to the selected autonomous service agents in connection with fulfillment of a particular request by the consumer; (c) a settlement engine configured to aggregate a plurality of autonomous transactions into deferred settlement groups based on responses from the selected plurality of autonomous service agents for fulfillment of the request by the consumer; and (d) a fulfillment verification engine configured to validate execution results from the service agents associated with the plurality of autonomous transactions in the deferred settlement groups prior to settlement authorization.

### CROSS-REFERENCE TO RELATED APPLICATIONS

This application is based on and claims priority to Irish Short Term Patent Application Number S2025/0205 and U.S. provisional application 63/865,886, the contents of both of which are hereby incorporated herein by reference.

### FIELD OF INVENTION

The invention relates to an agent platform for commercial transactions and to method of an artificial agent for commercial transactions, and specifically to computer-implemented agent capable of providing payment functions for accessing content.

### BACKGROUND

Artificial Intelligence (“AI”) agents are increasingly relied upon to fetch real-time, structured data (e.g., stock prices, weather forecasts, sports scores), but most valuable data sources have historically been locked behind costly enterprise subscriptions. There is a technical problem for AI agents to infer gated real-time data.

As an example, AI-powered Computer Using Agents (CUA), such as OpenAI Operator or Google Mariner, may be relied upon to carry out tasks on behalf of a user on a user's device. A user may provide such an AI agent with a request, a task, a prompt or command, and the agent may with some degree of autonomy, carry out the command as it see best fit on behalf of the user on the user's device. This may include accessing web pages or apps, as a user would, to get information or carry out interactions on these on behalf of a user.

The proliferation of gated (or paywalled) content, imperative in the domains of news, entertainment, education, and e-commerce has heightened the need for users to submit personal information, create accounts, or make monetary payments prior to accessing valuable resources. While these measures serve the dual purpose of monetizing content and securing user data, they inadvertently create significant hindrances for AI agents. Specifically, AI agents often struggle with navigating complex user interfaces, overcoming CAPTCHA challenges, and managing sessions tied to user accounts, which can lead to inefficiencies, abandoned processes, and suboptimal user experiences.

One of the foremost challenges AI agents face when attempting to access web pages that require registration or payment is the inherent complexity of authentication processes. Many websites implement multi-step account creation processes or require formal email verification to complete registration. This complexity is compounded by the diverse array of form fields, consent checkboxes, and privacy agreements that vary significantly across different sites, effectively precluding AI agents from automating the registration process without prior user interaction. As a result, AI agents must either mimic human behaviours painstakingly to navigate these processes or abandon accesses altogether.

Additionally, payment gateways integrate safeguards designed to protect against unauthorized transactions, including but not limited to credit card validation, identity verification, and fraud detection mechanisms. These layers of security present further obstacles for AI agents by necessitating direct interactions typically reserved for human users. The automation of payment processes thus remains fraught with challenges, often requiring AI agents to develop sophisticated logic for the secure handling of sensitive financial information which, while theoretically possible, presents legal and ethical quandaries regarding user data protection.

There is also a (somewhat well-founded) hesitation to give an AI agent access to a credit card. At the time of writing, AI agents are still not reliable to actually carry out the task given to it in a reliable manner. Giving credit card access to an AI agent may mean the AI agent would spend more money than intended or spend it to access content that is not desirable by the credit card owner.

The implications of these access barriers are profound. As the reliance on AI agents increases in both personal and professional realms, ranging from data collection for research purposes to routine monitoring of competitive pricing, ineffective interactions with registration or payment-protected content impede progress, reduce productivity, and ultimately hamper the effectiveness of automation strategies. This perpetuates a cycle where AI agents are limited in functionality, advanced capabilities go untapped, and users must rely on slow and labour-intensive methods to obtain the information or services they seek.

Most valuable data sources for retrieving information have historically been locked behind costly enterprise subscriptions. This and the above hindrances for AI agents to access and/or retrieve information, present technical problems in accessing gated data at will. The objective of the present invention is to overcome these technical problems.

### SUMMARY OF THE INVENTION

The objective of the present invention is to overcome the above-referenced technical problems. In particular, the objectives may be achieved by an distributed autonomous transaction platform comprising: at least one processing unit adapted to provide: a transaction orchestration engine configured to generate machine-readable transaction objects representing autonomous commercial intents associated with fulfillment of a consumer request; a routing engine configured to dynamically select among at least one of a plurality of autonomous service agents based on trust scores, pricing conditions, computational efficiency, and policy constraints, and route the machine-readable transaction objects to the selected at least one of a plurality of autonomous service agents; a settlement engine configured to aggregate a plurality of autonomous transactions into deferred settlement groups based on responses from the selected at least one of a plurality of autonomous service agents for fulfillment of the consumer request; and a fulfillment verification engine configured to validate execution results from the service agents associated with the plurality of autonomous transactions in the deferred settlement groups prior to settlement authorization.

In one embodiment, the processing unit is adapted to dynamically determine a trust score associated with at least one consumer agent or service agent based on at least one of historical transaction behavior, fulfillment reliability (e.g., fulfillment verification results), behavioral anomaly detection, organizational affiliation, cryptographic identity verification, delegated authorization status, and policy compliance history settlement history, or policy compliance. In another embodiment, the service agent offering comprises at least one of a machine-readable capability descriptor including pricing parameters, service availability, licensing restrictions, and trust indicators. In yet another embodiment, the settlement is deferred until at least one of a predefined monetary threshold, usage threshold, and time interval, is reached.

The disclosed platform addresses technical problems associated with autonomous machine-to-machine commercial interactions across heterogeneous systems and networks. In contrast, existing systems are unable to efficiently support high-frequency autonomous transactions between AI agents and distributed services due to: incompatible communication formats between autonomous systems; inability to dynamically negotiate machine-readable commercial terms; excessive transaction overhead associated with fine-grained microtransactions; lack of trusted autonomous identity verification; inability to verify machine-delivered fulfillment; inefficient real-time settlement requirements; fragmented API authorization and access control systems; inability to dynamically enforce licensing or usage restrictions; lack of scalable orchestration for multi-agent request fulfillment; and inability to coordinate deferred settlement across distributed autonomous systems.

The invention improves computer functionality and distributed machine interaction by introducing a machine-native orchestration and settlement infrastructure configured to coordinate autonomous commercial interactions between consumer agents and service agents. Further, such machine-native economic orchestration infrastructure coordinates autonomous agents operating across heterogeneous systems with deferred settlement, policy enforcement, trust validation, rights-aware access control, dynamic pricing, and usage verification. Accordingly, the invention provides technical improvements in distributed autonomous transaction systems by: reducing communication overhead between heterogeneous autonomous systems; enabling asynchronous deferred settlement of machine-generated microtransactions; dynamically routing requests based on computational, economic, and trust parameters; enabling machine-readable capability and pricing negotiation; improving reliability of autonomous fulfillment verification; reducing redundant authentication and authorization exchanges; enabling coordinated execution across multiple service agents; improving scalability of high-frequency autonomous commerce systems; enabling dynamic rights-aware access enforcement for machine-consumable resources; generating structured machine-verifiable transaction records suitable for audit, settlement, and policy enforcement.

In certain embodiments, the platform generates normalized transaction objects representing machine-readable commercial intents, service capabilities, settlement terms, trust requirements, and fulfillment conditions.

The objectives may also be achieved by an agent platform, comprising: a communication interface configured to facilitate interactions between the platform and a plurality of consumer agents and service agents; a processing unit operatively coupled to the communication interface and configured to: receive and interpret service agent input to determine service agent offering; receive and interpret consumer agent input data to determine a consumer intent associated with a consumer request, the consumer request comprising a request for a product or a service in exchange for money or a task; match the consumer request with at least one service agent based on predefined rules, context, or user preferences; and facilitate execution of the user request by enabling communication and/or data exchange between the consumer agent and the matched service agent; and a database operatively coupled to the processing unit and configured to store data associated with consumer agents, service agents, and interactions on the platform, wherein the platform is operable to dynamically adapt to changes in consumer intent and service agent availability to optimize request fulfilment.

The invention allows AI agents to interact with external APIs, services, and data stores via microtransactions. It provides a seamless, structured payment and data retrieval system, allowing AI-driven applications to access timely, gated, and monetizable information while ensuring efficient and transparent financial transactions.

The invention provides a structured orchestration for AI-to-API transactions, enabling: granular, per-use access to high-value data stores instead of requiring expensive monthly fees, payments between services that have never worked together before via escrow-like mechanisms; and prioritized transactions for existing vendors, ensuring data monetization flows through participating partners.

In one embodiment, the platform has access to at least one service agent of the service agents on a subscription basis and offers the product or service of the service agent to the consumer agents on a pay-per-use basis such as per-query basis or per session basis.

In one embodiment, a consumer agent is a search engine, wherein the search engine may purchase information on behalf of a user.

In one embodiment, the agent platform allows deferred payment of the product or the service requested.

In one embodiment, the agent platform acts as an escrow for payment until the product or service is delivered.

The platform as an escrow may act on third-party delivery notification, may require an acknowledgment signal from the consumer agent, and/or may apply a timeout after which delivery is presumed.

In one embodiment, the service agent is a commercially aware agent adjusting offers for products or services based on negotiations with consumer agents or based on supply and demand for its products of services.

The negotiations my include the service agent receiving real-time demand signals (e.g., concurrent request volume for its service) and adjust price accordingly, or that negotiation consists of an offer and counteroffer exchange over the communication interface.

In one embodiment, the commercially aware agent is a claimed agent, such as being certified by the provider of the offered service or product.

In one embodiment, the commercially aware agent is a third-party agent, such as by written without involvement or consent of the provider of the offered service of product.

In one embodiment, the consumer agent is configured to negotiate a product or a service on behalf of a user.

In one embodiment, the service agent is a smart marketing aware agent, promoting a product or a service on behalf of a seller.

An agent may be instantiated as a software component such as a mobile app, browser extension, embedded script, or standalone application running on a user device or server environment.

In certain embodiments, the agent platform supports alternative compensation models, including token-based payments, task-based access, or barter-style exchange of services and data.

In some cases, agent matching may occur externally to the platform, such as via federated directories or brokered agent hubs. The platform may validate and finalize transactions initiated through such off-platform processes.

Agents may employ retrieval-augmented generation (RAG) architectures for interpreting natural language queries and generating structured API requests, leveraging contextually relevant embeddings or taxonomy-based prompts.

RAG architectures may involve retrieving contextually relevant information to augment the consumer agent's query or the service agent's promotional content.

For complex requests, the platform may coordinate multiple service agents to fulfil subcomponents, handling partial result processing, merging, and proportional payment distribution.

Proportional payment distribution may be based on the fraction of the consumer request each service agent fulfils, or on predefined contribution weights.

The AI platform may include modules for legal and regulatory compliance, including verification processes for agents and structured logging of sensitive actions for audit or tax purposes.

The above-identified objective and other objectives of the present invention are achieved by a computer-implemented method comprising: a) initiating, by a user, a task at an artificial agent (the agent), such as an artificial intelligent or intelligent agent, in particular a computer-using agent (CUA); b) sending, by the agent, a request for accessing an entity, such as a web page or application, hosting content; c) receiving, by the agent, a response indicating that the access requires a payment and/or that an option for deferred payment is available; d) accessing, by the agent, the content, wherein the option for deferred payment is activated; and e) using, by the agent, the content for carrying out the task.

Advantages include facilitating automated task completion by artificial agents. Getting access to restricted content by artificial agents requires a lot of processing power and thus electricity, e.g. for filling out forms, answering emails, and/or solving CAPTCHA puzzels. Electricity usage by artificial agents such as AI agents is a growing concern. Facilitating artificial agents, such as AI agents to complete the task based on external agents will be of increasing technical importance, e.g. to balance grids.

The objectives may further be achieved by a corresponding computer-readable medium and a system carrying out the above method.

As used herein, the term “agent” refers to a user agent, which may be a software application that acts on behalf of a user to retrieve, render, and interact with content accessible over a network, such as the internet. The “agent” essentially acts as a client in a client-server system, communicating with servers to fetch information, processes, store, and/or display it to the user. A computer-using agent is a software that at least in part is executed on a user's device, and interacts with the user's device by using or simulating the input devices available to the user, typically using or simulating keyboard and mouse input signals.

Also, as used herein, “entity” refers to a software application such as a web page, database, or any other application from which content, e.g., information, video, audio and images, and/or processed data can be accessed or otherwise retrieved by an agent, which may require the agent to be granted permission to access or retrieve such content and/or processed data.

The term “predefined rule” according to context of user preferences may include category matching, price ceiling enforcement, trust-level filtering, and/or geographic or regulatory eligibility checks.

As described herein, a “threshold” may be a monetary balance (e.g., the sum of outstanding ledger entries) and/or an elapsed time, and that the processing unit may monitors a tab balance against the configured threshold.

In some embodiments, the “artificial agent” is any type of artificial intelligence agent, in particular an agent based on artificial intelligence (AI, e.g. neural network-based models of artificial intelligent) for performing task on behalf of a user, in particular Computer-using agents, wherein the agent operations are provided by one or more software programs executed on one or more computer servers or other electronic devices, which could act as a human would, or an agent for collecting data for training such models. It is possible for the user device to be the computer server implementing a portion of or all of the operations of such agent. The invention relies on pre-trained models (such as those provided by OpenAI Operator or Google Mariner) for inferring agent actions based on task description provided by a user. The model is fed with a context (model input), typically involving data derived from task description and current and/or recent screen layout. Based on the context, the model will produce (infer) actions (model output) for the agent to take on the user device, such as moving/clicking mouse and typing keyboard. Actions may also include lower-level device instructions.

In one embodiment, the term “artificial agent” is broadened to include bots for harvesting data for performing task on behalf of the user or for any other purpose.

The invention provides a method for allowing agent to access paywalled content when executing tasks on a computer. In one embodiment, step d) includes providing, by the agent to the entity, a token of identification.

In one embodiment, the token is based on a unique secret key, shared between the agent and a payment server, in advance.

In one embodiment, step d) includes sending, by the entity to the payment server, a signal based on the token, notifying the purchase of an access to the content.

In one embodiment, the payment server, if the token is invalid, sends a signal to the entity, notifying that the token is invalid.

In one embodiment, the token is ephemeral, valid for a short period, such as for 5 minutes.

In one embodiment, step c includes providing, by the agent to the entity, user credentials on behalf of the user.

In one embodiment, the token is a Time-based One-Time Password, TOTP; wherein the unique secret key, such as a base32-encoded string, is shared between the agent and the deferred payment in advance, preferably the agent accessing a page containing a QR-code containing the unique secret key.

In one embodiment, the content is provided as pay per access, PPA.

In one embodiment, the payment server monitors the amount of spending, and inactivates the token, or refuses to share a unique secret key with the agent, when an amount threshold is reached.

In one embodiment, the payment server provides the agent with the token, after an interaction with the user, asking for approval for a spending.

In one embodiment, token-based payment involves transfer of a defined number of digital tokens from the consumer agent's wallet to the service agent's account upon confirmation of service delivery.

In one embodiment, an amount of spending increases with each interaction of approval between the payment server and the user.

In one embodiment, the payment server is a deferred payment server.

The problem is further solved by a computer-implemented method for completing a task by an agent software application executed at least on part on a user device, the method comprising: a) providing, by a user using the user device, a task description for the agent, such as by the user typing a prompt for the agent, describing the task; b) sending, by the agent, the task description for inference as model input to a first model located on a computer server; c) determining, by the computer server, first actions to be taken by the agent on the user device for completing the task, by using the task description as model input to the first model, wherein the first actions include requesting access to an entity, such as a web page or application hosting content; d) receiving, by the agent from the computer server, the first actions; e) controlling the user device by the agent according to the first actions, including requesting the content from the entity; f) identifying, by the agent at the user device, that the content is blocked, and that agent-readable payment is available; g) accessing the content, by the agent, using the agent-readable payment; h) receiving, at the user device, the content; and i) completing, by the agent at the user device, the task based on the content.

In one embodiment, step i) of completing the task based on the content, comprises: i1. sending, by the agent, the content for inference as model input to a second model on the computer server; i2. determining, by the computer server second actions to be taken by the agent on the user device, by using the task description and content as model input to the second model; i3. receiving, by the agent at the user device, the second actions, i4. completing, by the agent, the task on the user device according to the second actions; wherein the first model and the second model may be a same model, or separate models.

The invention provides independent, trusted and reliable grading/scoring of service performance applicability to a given task. Provides pricing negotiation enabled without direct exposure of consumer spend limits (i.e. stop services from charging the maximum possible at all times). It provides competitive market/bidding, and isolation of identity and

Mediating between services and consumers enables scoring services on efficacy/pricing etc, provides abstraction of payment/disbursements mechanisms to support micropayments and a variety of other existing payment standards, and management of associated financial risks.

### BRIEF DESCRIPTION OF THE DRAWINGS

In the following, embodiments of the invention are described with respect to the figures, wherein:

FIG. 1 shows a representative method according to an embodiment of the present invention;

FIG. 2 depicts a representative system according an embodiment of the present invention;

FIGS. 3 through 5 depicts exemplary sequence diagrams according to certain embodiments of the present invention;

FIG. 6 shows an agent platform according an embodiment of the present invention;

FIGS. 7 through 9 depicts implementations of the present invention; and

FIG. 10 depicts a representative block diagram of an exemplary configuration of a distributed autonomous transaction platform according to an embodiment of the present invention.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It should be understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

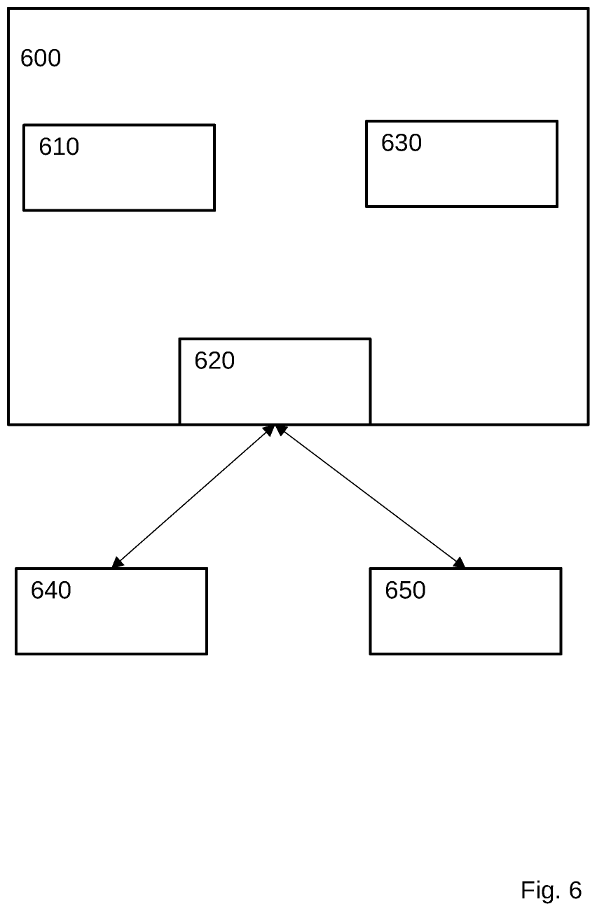

FIG. 6 depicts an agent platform 600 according to the invention comprising at least one processing unit 610, a communication interface 620, and a database 630. The communication interface 620 is configured to facilitate interactions between the platform and a plurality of consumer agents 640 and service agents 650.

The consumer agents may be AI bots to access data and services, e.g., weather data, stock prices, or a digital service.

A protocol allowing platform to receive agent input may be an API, such as implemented using Agent-to-Agent (A2A) or Model Context Protocol (MCP).

The service agents are typically bots or services that offer services, e.g., providing weather forecasts, performing tasks, or selling digital content.

The platform acts like a smart middleman that listens to both sides, figures out what the “consumer” wants, matches the consumer them to the right “service” based on rules, context, and preferences, It helps them complete the transaction.

Matching may be done in a multistage approach depending on the size of the available service set. A list may be maintained (of constrained size) of capabilities within the service set. This may be used to identify a superset of appropriate services. The superset may be filtered based on applicability, appropriateness, and/or pricing signals from the consumer. The matching may further include deciding on a best service for the task or present a menu of services to the consumer, depending on their desires.

Instead of needing an expensive subscription, a consumer agent may pay a substantially lower amount to obtain information it requires, akin to a—pay-per-use business model. The platform supports deferred payments enabling the user or AI to not have to pay immediately; payment can happen after a threshold or a time period.

The platform may also offer an escrow feature, where the platform holds the payment until the service is actually delivered.

Agents can be smart and adaptive, e.g. a service agent can adjust prices dynamically based on supply and demand, a consumer agent can negotiate prices before buying, agents can even be marketing-aware, promoting offers intelligently,

The processing unit 610 is operatively coupled to the communication interface and configured to receive and interpret service agent input to determine service agent offering.

The processing unit 610 is further configured to receive and interpret consumer agent input data to determine a consumer intent associated with a consumer request, the consumer request comprising a request for a product or a service in exchange for money or a task. Consumer request metadata may contain “category” (e.g., “weather”), “request” (e.g., “seven-day forecast for ZIP 04074”), “client_id” (e.g., “1234”), and “user_price_limit” (e.g., “10ct”).

The platform may determine consumer intent by map task context information to the constrained capability set for initial filtering (traditional search/filtering), and make LLM based (agentic) appropriateness decisions based on task, context, and/or consumer history. As a trusted and neutral mediator consumers can share context with the platform without leaking too much information to service providers (i.e. the platform may act as somewhat of an air gap to protect commercial interests of consuming parties).

The processing unit 610 is further configured to match the consumer request with at least one service agent based on service agent offering and pre-defined rules, context, or user preferences.

The processing unit 610 is further configured to facilitate execution of the user request by enabling communication and/or data exchange between the consumer agent and the matched service agent.

The database 630 is operatively coupled to the processing unit and configured to store data associated with consumer agents, service agents, and interactions on the platform, wherein the platform 600 is operable to dynamically adapt to changes in consumer intent and service agent availability to optimize request fulfilment.

Service agent input and/or consumer request may be based on Representational State Transfer (REST) architecture.

Wherein the consumer agent is an AI agent acting on behalf of a user request, The consumer agent may format the response using a RAG architecture model and presents it to the user. The consumer agent may also be trained on the service agent categories available at the agent platform, and send a provide consumer agent input data according to categories available.

Money received from user may be split between data provider (e.g., weather. com), agent platform fee, and requesting AI consumer agent (e.g., deepakChopra.ai).

When a service agents is an AI marketing aware agent, promoting a product or a service on behalf of a seller, the product or service may comprise a digital asset, wherein the digital asset may be retrieved and incorporated with the service agent using a RAG technique.

It is intended that the scope of the present invention be defined not only by the literal terms of the claims, but also by their fair meaning as understood by those skilled in the art. The invention encompasses all variations, modifications, and equivalents that fall within the spirit and scope of the claims, including any implementations that may not be explicitly described herein. Therefore, any terminology used in the specification and claims should be interpreted expansively to cover all forms, alternatives, and embodiments that a person of ordinary skill in the relevant field would recognize as being within the invention's intended scope and purpose.

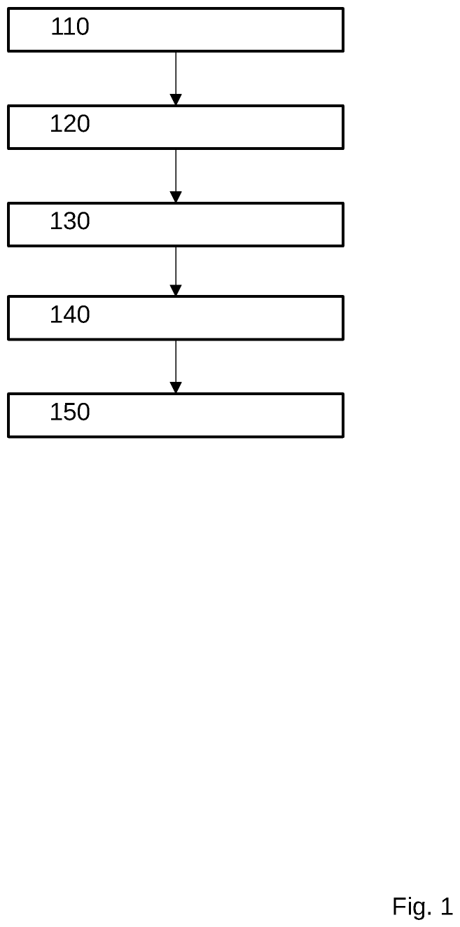

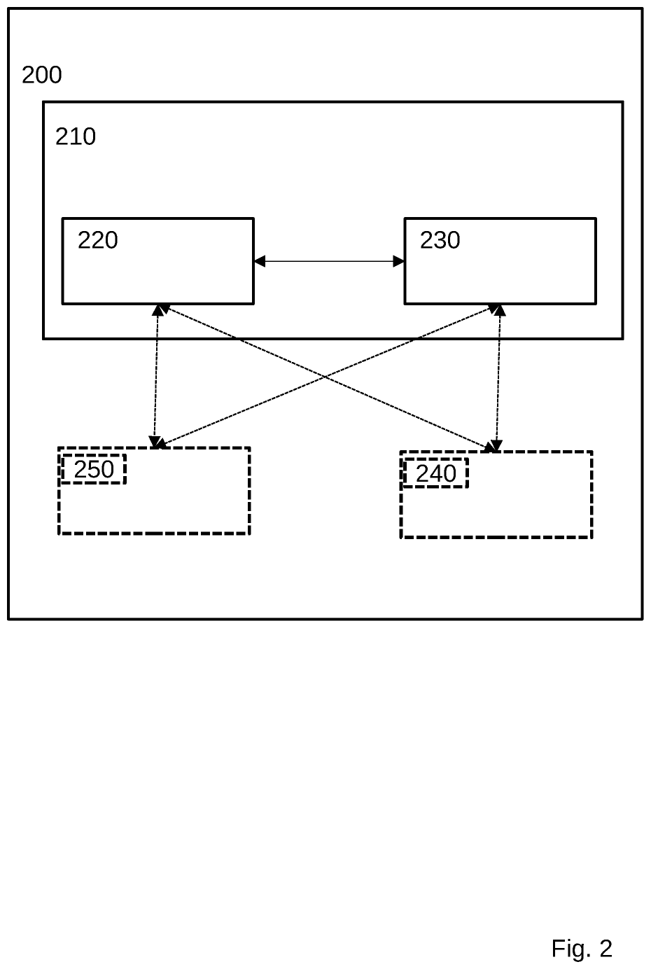

FIG. 1 depicts an exemplary method according to the present invention. The method includes: a) initiating 110, by a user, a task at an agent 220 (shown in FIG. 2), such as a computer-using agent. The task may be described by the user as a prompt or otherwise initiated by the user. The agent may, based on the task description or details, determine that a specific content is desired to complete the task, and further localizing an entity 230 (also shown in FIG. 2), such as a web page or application, hosting the content.

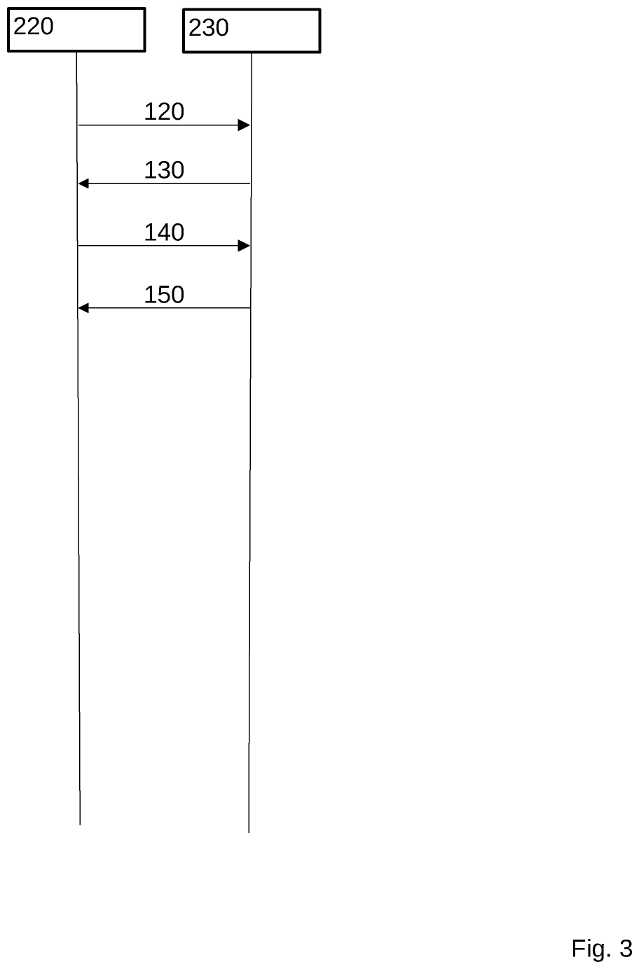

The method may further contain b) sending 120 a signal, initiated by the agent 220, accessing the entity 230; c) providing 130, by the entity 230, a wall for accessing the content, the wall including an option for deferred payment; d) accessing 140, by the agent 220, the content, wherein the option for deferred payment is activated; e) using 150, by the agent 220, the content for carrying out the task. The method is shown as a sequence diagram in FIG. 3. The operations of the agent 220 may be provided by one or more software programs executed on one or more computer servers or other electronic devices. It is possible for the user device to be the computer server implementing at least a portion of the operations of the agent 220.

As shown in FIG. 2, which is described in detail below, the agent 220 may provide the entity 230 with a token, such as a digital token, to identify itself, and preferably also to allow the entity 230 to establish that the agent 220 is not a malicious bot. This may be used to circumvent a test, such as, e.g., a CAPTCHA test, that requires unnecessary processing power for the agent 220 to solve, or block the agent. The token may be based on a shared secret, shared between the agent 220 and a payment server 240, such as a payment server for deferred payments, in advance. The secret may be hashed with a certain timestamp to generate the token, making to possible to limit the token's usage in time, and sent to the entity 230 for identification. The token may be based on a shared secret, and generated as a Time-based One-Time Password, TOTP or an alternative solution such as counter based e.g. HMAC-based one-time passwords (HOTP), or from a list of one-time passwords (shared secrets) shared between the agent and the payment server in advance. The shared secret or secrets, or tokens may be associated with an account at the payment server, wherein the payment server keeps track of purchases made by the agent on the account, wherein each agent may have access to one of more accounts.

The entity may signal that it allows agent payment (“agent-readable payment”), for example by providing a certain text, or a code. The agent may also be provided with a list of entities (e.g. domains) allowing agent-readable payments from the payment server, or asking the payment server if the entity allows its type of agent-readable payments. The entity may signal that it allows agent readable payment using a visual recognition, such as with a QR code, or with audio signals.

The purchase price of the content may be lower for the agent than for a human accessing the same content, because, for example, the agent is only using the text to complete a certain task, and most likely not interested in the whole content. The content is typically not provided for model training, but for inference. The advantage of the approach is that paywalled content is accessed when actually used, and allows content to be used for completing tasks, which are frequently updated, such as paywalled news, stock prices or reviews, weather forecast, etc.

The entity 230 may in turn forward the token to the payment server 240 for identification and confirmation, and to notify the payment server 240 that a purchase of content is made, i.e. including a purchase price for which the agents purchased the content for. The payment server 240 may check if the token is valid, e.g. based on a same shared secret, such as by hashing a same secret with a same timestamp and checking if the hashes match. The payment server may also check if an account corresponding to the token has not reached a limit or is inactive. The payment server 240 may be based on such checks that respond with a confirmation or OK, to enable the purchase to proceed. The entity will then know that the agent is an agent, and not a human, and that the payment for agent agent-readable payment is accepted. In response, the entity may provide the agent with the content and may also tailor the content for agent inference.

Alternatively or in addition, the payment server 240 only respond when the payment is not allowable, for any reason, notifying the entity 230 that spending is not allowed.

The payment server 240 may identify the account with the token, by the token containing a user identification, in addition to a hashed secret. Alternatively, the payment server 240 may generate hashed secret for all accounts, and check each until a match is found, enabling it to identify the account. The timestamp may be changed on certain pre-known intervals, such as every 10 s, 30 s, 1, 2, 3, or 5 minutes. The payment server 240 may use the same interval to generate hashed secret when checking against the received token. Either a timestamp used for hashing is sent with the token, or the payment server 240 using the last timestamp. In order to overcome issues with the timestamp generated just before a timestamp change, the payment server 240 may allow one of a number of acceptable previous timestamps, as well as the latest timestamp, to be valid.

As an alternative, or in addition to a token, the agent 220 may be provided with user credentials, such as username and password, for identification on the entity 230 and/or the payment server 240. Such solution may not allow the agent 220 to overcome CAPTCHA issues, unless the credentials are particularly issued for agent allowance.

The agent 220 may also enter and/or send a code to the entity 230, that is generated by an agent provider 250, such as by OpenAI Operator or Google Mariner, allowing the entity 230 to establish that it is an agent operating on behalf of the user device 210, and not a human. This may allow the entity 230 to tailor the response, in particular to skip any CAPTCHA or other bot testing aspects. It may also provide a text that is more computer readable, and not particularly human readable. This may save computing power for the agent, and thus save agent electricity and CO2 footprint. The code may be any type of secret, that the entity 230 may send to the agent provider 250 to get confirmation that the secret is valid, or it may be based on a public/private key, wherein the code is signed by the agent provider 250, and the entity 230 may check with a public key of the agent provider 250 that the code is valid. The entity may be generating a secret and provide it in place, or in addition, to a CAPTCHA, and the agent forwarding the secret to the agent provider for signing, and returning it signed to the entity. Alternatively, or in addition, the agent provider may also sign something that is not provided by the entity, for the entity to validate.

Just as for the above token, the code may be time limited, such as by signing/hashing a timestamp with the code/secret, and/or the secret becoming invalid after a certain time period.

The agent provider 250 may be a provider of a model for agent inference, such as by training and configuring such models, and/or a provider of agent model inference.

The agent 220 may store an identification that is unique for each user device 210, user, or agent. This may be part of a model input, or otherwise sent with or in addition with context for inference, wherein the agent provider 250 may sign it and provide the signed identification as part of the response, wherein the agent 220 forwards the signed identification to the entity. The entity may then check not only that the request originates from an agent, but also the identity of the user tasking the agent 220. The identification may be the token, based on a shared secret between the agent 220 and the payment server 240, wherein it is the token that is then signed by the agent provider 250.

For the purchase of content, the entity may send the token to the payment server 240, wherein the payment server 240 checks that the token is valid, and that purchase is accepted.

The secret may be shared between the agent 220 and the payment server 240, by means of the agent 220 accessing a page provided by the payment server 240, showing a QR-code, or the secret may be otherwise shared, such as sending it over an end-to-end encrypted channel. If the token is based on a list of one-time passwords, these may be shared in advance in a same manner.

The content provided by the entity to the agent may be provided as pay per access, PPA, i.e., each time the agent access the entity, or pay per view, i.e. each time the agent request the content, or purchase based, requiring payment only the first time the agent requests the content. It may also be subscription based, allowing access for a certain period to the requested content, or a bulk of content provided by the entity. The content may also be free and/or limited for agent, wherein full and/or purchase is required for humans, and/or other bots are blocked.

The payment server 240 may monitor the amount of spending, and inactivate the token, the account, or shared secrets or secret, or refuse to share a unique secret key with the agent 220, when an amount threshold is reached. The payment server 240 may then communicate with the entity (or with all entities using the agent-readable payment method) that the token or account is invalid until further notice.

The payment server 240 may provide the agent 220 with a valid secret, after an interaction with the user, asking for approval for a spending. The amount of spending allowed (spending limit) may be adjustable, and my increase with each interaction of approval between the payment server 240 and the user. If the agent 220 spends the money wisely (i.e. acceptable by the user), more spending may be allowed before reaching the limit. After reaching the limit, the user may have to settle the debt, before an account can be activated again, with a new spending limit. I.e. the payment server is a deferred payment server. The spending may also be pre-paid.

FIG. 2 depicts a system 200 according to an embodiment of the present invention. The system 200 comprises a user device 210, an agent 220 such as a computer using agent, an entity 230, such as an application or web server, providing paywalled content. The system 200 is configured to carry out the method described herein.

The system 200 may optionally (dashed in FIG. 2) comprise a payment server 240. The agent 220 or user may access the payment server 240 provider to retrieve a shared secret for generating a token. The payment server 240 may also be accessed to settle debt or pre-pay spending.

A unique token may be part of the model input, and/or provided by the operating system (OS) or application of the user device 210 on accessing a paywalled entity, such as one allowing payment by the payment server 240. The token may be hidden, not visible to the user, but visible to the agent 220 when completing task on behalf of the user, such as hidden text in a web page. The token may be sent to the entity by the agent 220 when completing task on behalf of the user accessing the entity 230.

The system 200 may also optionally (also dashed in FIG. 2) comprise an agent provider 250. Unless the agent 220 is fully inferred locally, i.e., the agent software application making deductions or predictions based on information within its local environment, the agent 220 may send information acquired on the user device 210 for completing the task (taking actions such as moving a mouse or typing text), to the agent provider 250 for inference. A code, such as the token, may be sent to the agent provider 250 during, with or in association with the data sent for inference. The code may be signed by the agent provider 250 as a marker that the action performed by the agent 220 is performed by an agent inferred by the agent provider 250. As an alternative to signing, the inference may include a time limited secret in the response, wherein the entity may check with the agent provider 250 that the secret is valid.

The user device may also be a virtual machine, operating to complete tasks on behalf of a user device executing the agent software application.

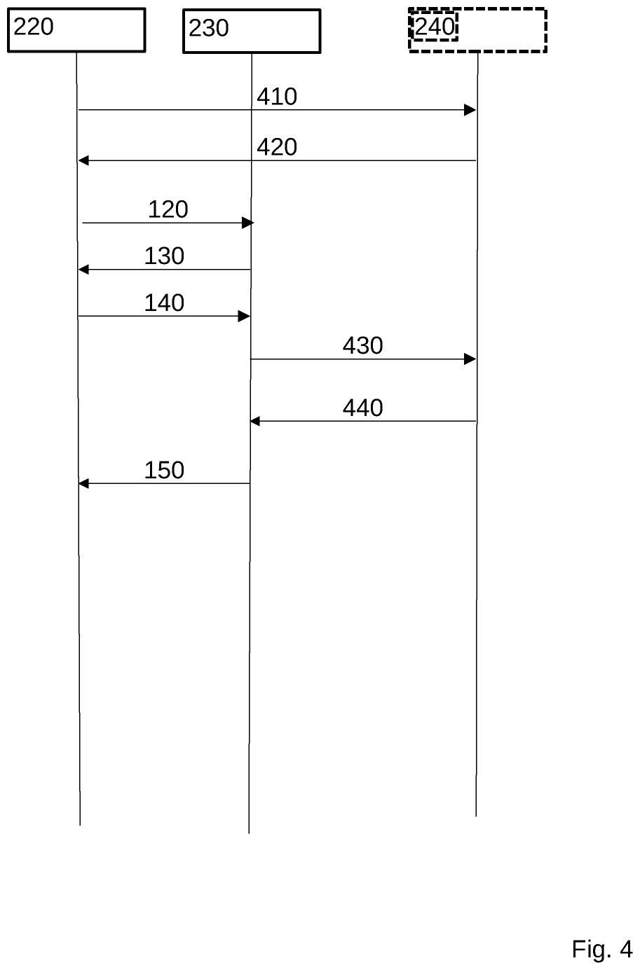

FIG. 4 depicts a sequence diagram according to an embodiment of the invention. The sequence is similar to the sequence of FIG. 3 with following additions. The agent 220 sends a request 410 to the payment server 240, initiating a sharing of a shared secret. The payment server 420 sends a response 420, securing one or more shared secret(s) between the agent 220 and the payment server 240.

The agent and/or the user device may generate a token based on the shared secret, such as by hashing the shared secret with a recent timestamp. When the agent 220 accesses 140 the entity 230, using the option of deferred payment, the agent 220 sends the token to the entity 230 with the signal 140. The entity 230, forwards 430 the token to the payment server 240 for validation. The payment server 240 validates and identifies the agent 220 using the token and responds 440 to the entity 230 accordingly.

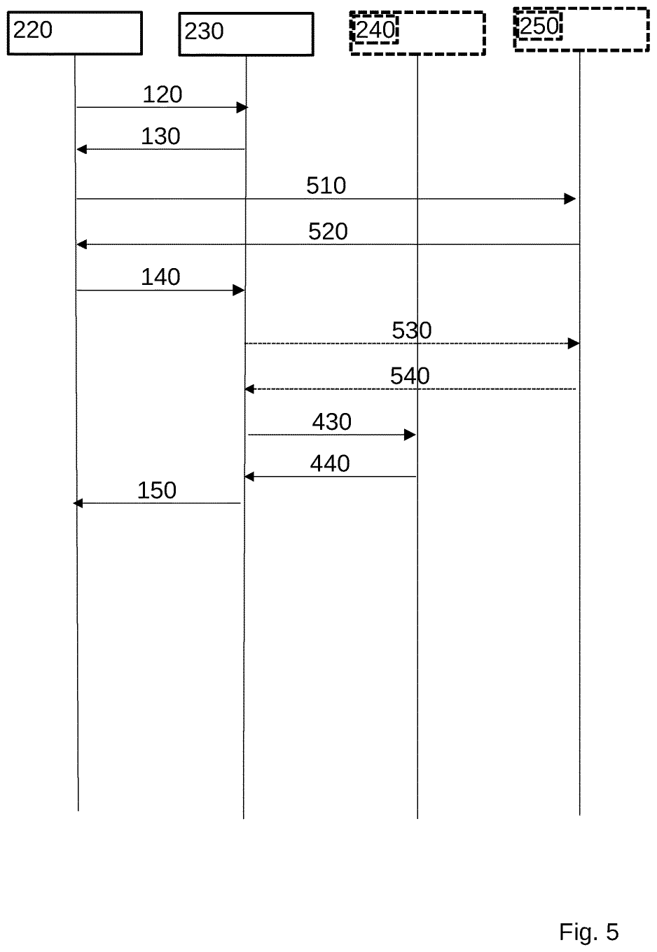

FIG. 5 depicts a sequence diagram according to an embodiment of the invention. The sequence is similar to the sequences of FIG. 3 and FIG. 4, with following additions. Upon sending 510 the content of the entity containing a paywalled content to an agent provider 250 for inference, the agent 220 includes a code for signing. The code may be the token as described above, or a code provided by the entity for agent validation. The agent provider 250 signs the code and provides it with a response for action to the agent 220. The agent 220 includes the signed code in accessing 140, from the entity 230, the content using an option of deferred payment. The entity 230, either forwards 530 the signed token to the agent provider 250 for validation 540 or checks the signed token using a public key of the agent provider. Upon validation, the entity 230 may be certain that the agent is an agent and not a human or a bot, and may take actions accordingly. The entity may forward the token to the payment server 240, as described above, for identification and for notifying purchase of content.

Validation may also include checking that the matched service agent is registered on the platform, checking that the proposed price falls within the consumer agent's stated price limit, and/or checking that both parties' trust indicators meet platform thresholds.

A computer-implemented method for completing a task by an agent software application executed at least on part on a user device, the method comprising:
a. providing, by a user using the user device, a task description for the agent. The task description may be given orally, or by typing a prompt for the agent. The task description describes a task, or information desired by the user.
b. sending, by the agent, the task description for inference as model input to a first model located on a computer server. The model is typically a generative model, trained to generate actions to be taken on a user device based on a task description. The model input may further comprise further context for inference, such as GUI layout on the user device, past actions or tasks performed on user device, and/or applications (including type and version of OS) running on user device.
c. determining, by the computer server, first actions to be taken by the agent on the user device for completing the task, by using the task description as model input to the first model, wherein the first actions include requesting access to an entity, such as a web page or application hosting content. Certain tasks might need information content accessible for external entities such as accessible using a browser or an app. This may be e.g. real time information and/or restricted information. The model may be trained to perform actions for accessing such entities for completion of the task.
d. receiving, by the agent from the computer server, the first actions. I.e. the computer server sends the actions as instructions for the agent to carry out on the user device.
e. controlling the user device by the agent according to the first actions, including requesting the content from the entity. The agent controls the user device in a manner that result in the user device requesting the content from the entity. This may involve e.g. opening a browser and entering a certain URL for accessing a certain content, or opening a search engine and searching for certain content, the in return getting a link for accessing the content from the entity.
f. identifying, by the agent at the user device, that the content is blocked, and that agent-readable payment is available. The identification may be a certain text image or sound at the entity, or a hidden identification in the source code sent in return to the request.
g. accessing the content, by the agent, using the agent-readable payment. The usage of agent-readable payment may include the agent identifying itself, such as using a unique token, and the entity allowing access to the content in return.
h. receiving, at the user device, the content. The content may be part of a text provided as display within a browser, or otherwise received at the user device.
i. completing, by the agent at the user device, the task based on the content. The agent may complete the task, at least in part using information contained in the content.

In certain embodiment, the accessing the content is a step of completing a task, wherein agent is further using the content at least in part to complete the task. The step j) above, of completing the task based on the content, may further include: j1. sending, by the agent, the content for inference as model input to a second model on the computer server. The model input may further comprise the task description, and or further context of the user device. The step may further include j2. determining, by the computer server, second actions to be taken by the agent on the user device, by using the task description and content as model input to the second model, and j3. receiving, by the agent at the user device, the second actions, j4. completing, by the agent, the task on the user device according to the second actions. The agent may control the user device based on instructions received with the second actions.

The first model may be a pre-trained model for inferring actions to be taken on a user device, based on task descriptions. The second model may be a pre-trained model for inferring completion of tasks, based on task description and content. The first and second model may be trained as a unity, or as separate models.

The methods of identification and/or payment provided herein for inference, may also be used for training, i.e., web-crawler bot paying for content for model training using the same methods of identification and/or payment. It may also be used for other bots than agents that are allowed to access paywalled content, either by identification as acceptable bots by a bot provider, and/or by paying an acceptable designated bot fee for accessing paywalled content.

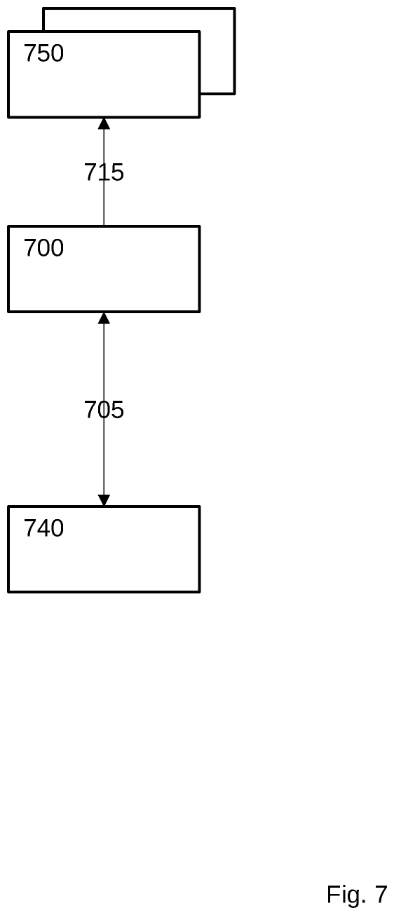

FIG. 7 shows Mediator (700) in connection with Consumer (740), and Services (Superset 750). The Consumer (740) provides a Request, including task signals (what do I want to happen), intent signals (in what context do I want this to happen), prising signals (how much am I willing to pay), and identity signals (who am I).

The Mediator (700) acts as neutral prising negotiator. It identifies applicable services from the Superset of services and scores services based on applicability and past performance. Identification of services may be based on known capabilities, and may also include further filtering (715). The Mediator (700) facilitate for the Consumer (740) to negotiate a price for each service (705).

The Services provide information regarding what tasks it is capable of performing, and the estimated cost of performing these tasks.

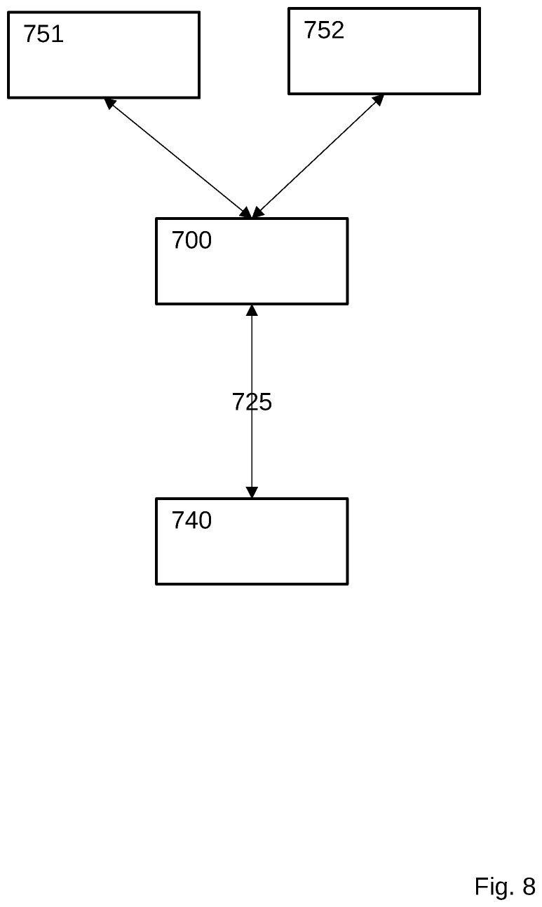

A next step is depicted in FIG. 8. The Consumer (740) agrees on a price (725) from Chosen service 751 and chosen service 752, and exchange data/results. The Mediator (700) tracks economic outcomes of the exchange, and tracks audit trail and structure responses.

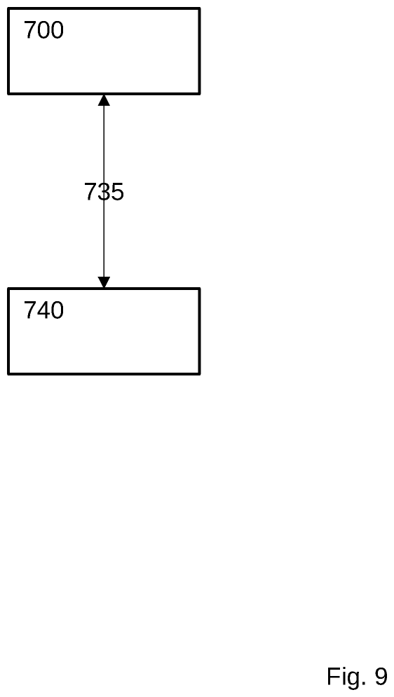

In next step depicted in FIG. 9, the Consumer (740) and Mediator (700) verifies the outcomes (735), and the Mediator records the outcome and scores each service for future optimisation of service choice.

The platform maintain a set of known consumers and their payment credentials/credit agreements and provide a mechanism for consumers to identify themselves (e.g. HTTP Signature/JWKS based). The platform further provide an interface for consumers to request services (somewhat similar to A2A/AP2). The request may include task or tasks (what do I want), underlying intent (in what context do I want it), pricing (how much am I willing to pay), identity (who am I), and this could happen over existing protocols or be proprietary.

The platform may further hold data containing set of known services (superset), filter services to those which may be appropriate to the requested task (subset) (a bloom filter may be used for fast search).

The platform may further provide functionality to invite subset service to bid for providing a service.

Filtering to appropriate services in a final set, may include exacting service provided, be based on past performance, willingness of the service to respond to specific request, and/or pricing vs consumer price signals.

The platform may further present services to consumer for a price agreement, mediate (comms protocol abstraction) between consumer and service, acquire performance signals from consumers (was the task performed successfully) for service scoring, hold history of consumer patterns (for further context information on task requests), provide ledger etc, and maintain authentication with services.

The services, in turn, declare capabilities and pricing estimates (estimate, floor, ceiling price for a given task).

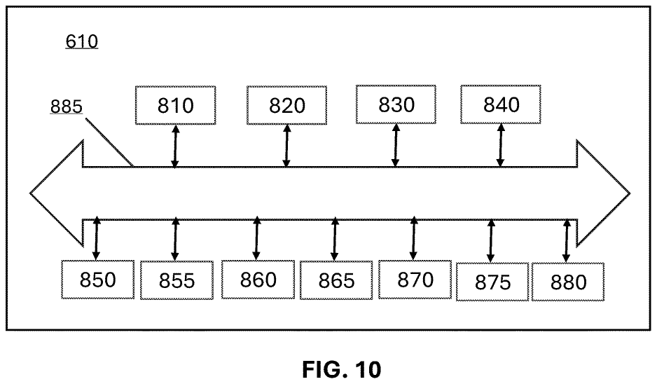

FIG. 10 depicts a particularly advantageous configuration of a distributed autonomous transaction platform 800 in accordance with this disclosure. The transaction platform 800 includes at least one processing unit 610 adapted to provide a transaction orchestration engine 810, a routing engine 820, a settlement engine 830 and a fulfillment verification engine 840. The transaction orchestration engine 810 may be configured to generate machine-readable transaction objects representing autonomous commercial intents associated with at least one request by at least one consumer. The routing engine 820 is configured to dynamically select from at least one of a plurality of autonomous service agents based on at least one of trust scores, pricing conditions, computational efficiency, and policy constraints, and route the machine-readable transaction objects to the selected at least one of a plurality of autonomous service agents in connection with fulfillment of a particular request by a particular consumer. The service agent may have at least one of a machine-readable capability descriptor including pricing parameters, service availability, licensing restrictions, and trust indicators The settlement engine 830 may be configured to aggregate a plurality of autonomous transactions into deferred settlement groups based on responses from the selected at least one of a plurality of autonomous service agents for fulfillment of the request by the particular consumer. The fulfillment verification engine 840 may be configured to validate execution results from the service agents associated with the plurality of autonomous transactions in the deferred settlement groups prior to settlement authorization.

For performing their respective operations and communicating with one another, the respective engines 810, 820, 830 and 840 may further receive and/or exchange information with trust engine 850, policy enforcement engine 855, pricing engine 860, rights management engine 865, transaction aggregation engine 870, compliance engine 875 and identity verification engine 880 via one or more communications channels 885. The respective engines 810 through 880 may operate independently, sequentially, in parallel or other combinations within distributed computing environments of the at least one processing unit 610. The respective engines 810 through 880 may also operate to intermittently or continuously exchange status information as may be needed between one another for keeping synchronized with regard to the status of one or more of the transactions of the plurality of transactions as such is being processed for potential settlement by such respective ones of such engines 810-880. In addition, the platform 800 may utilize event-driven architectures, asynchronous communication protocols, distributed state synchronization, and queue-based processing mechanisms for coordinating autonomous interactions between agents.

In some embodiments, service agents may transmit or otherwise make accessible to certain or all of the platform engines 810 through 840, machine-readable descriptors regarding the capabilities of such service agents. Such machine-readable capability descriptors may include, for example, service categories, pricing parameters, licensing restrictions, supported data formats, latency guarantees, availability indicators, trust scores, settlement preferences, geographic restrictions, computational requirements, authentication requirements, freshness indicators, and/or confidence metrics. The trust scores may advantageously be generated based on at least one of historical settlement reliability, transaction dispute frequency, fulfillment verification results, behavioral anomaly detection, organizational affiliation, cryptographic identity verification, delegated authorization status, and policy compliance history.

In an analogous manner, the consumer agents may transmit or otherwise make accessible to certain or all of the platform engines 810 through 840, machine-readable intent objects, which may include, for example, requested service categories, urgency indicators, budget constraints, trust requirements, preferred settlement methods, privacy requirements, geographic preferences, authorization credentials, computational limits, and/or result quality thresholds.

The platform 800 may dynamically generate executable machine-readable transaction agreements between consumer agents and service agents based on compatibility between capability descriptors and intent objects.

The at least one processing unit 610 may comprise respective processing units co-located or distributed over a network, such as the internet, or a plurality of networks including, for example, the internet and local area networks, or over a plurality of local networks. The at least one processing unit 610 may select from multiple service agents using routing algorithms based on one or more of latency, historical fulfillment quality, trust score (determinerd by, for example, the trust engine 850), pricing, availability, computational efficiency, geographic proximity, energy consumption, licensing rights (as determinerd by, for example, the rights management engine 865), settlement risk, compliance requirements as determinerd by, for example, the compliance engine 875), and historical transaction success rates.

In some embodiments, the platform 800 may intermittently or continuously recalculates routing decisions during transaction execution based on changing network, pricing, or availability conditions.

In some embodiments, the transaction aggregation engine 870 may aggregate multiple autonomous transactions into deferred settlement groups associated with one or more agents, users, organizations, or sessions. Settlement may occur or triggered upon, for example, (a) reaching a monetary threshold, (b) expiration of a time interval, (c) fulfillment verification, (d) policy approval, (e) completion of a multi-agent workflow, (f) reaching a trust score threshold determined by the trust engine 850, and/or (g) completion of usage aggregation.

In other embodiments, the platform 800 may extend provisional transaction authorization to autonomous agents prior to final settlement based on, for example, historical transaction behavior, fulfillment confidence scores, trust scores, organizational policies, identity verification (as determined by, for example, the identity verification engine 880), settlement history, and/or fraud probability estimation.

In further embodiments, fulfillment verification by the fulfillment verification engine 940 may be performed without direct human intervention, and include, for example, cryptographic verification (which may be in the form of receipts), signed execution receipts, output hashing, response integrity validation, output validation, proof-of-computation verification, challenge-response verification, usage attestation, timestamp verification, and/or consensus validation from multiple service agents. The platform 800 may also generate for fulfillment verification by the fulfillment verification engine 840, immutable transaction logs representing, for example, request parameters, fulfillment status, settlement state, policy decisions, verification results, and/or rights enforcement decisions.

In some embodiments, the policy enforcement engine 855 may enforce one or more dynamic policies, such as for example, spending limits, rate limits, jurisdiction restrictions, vendor allowlists or blocklists, regulatory requirements, approval workflows, risk thresholds, escalation triggers, content restrictions, privacy constraints, usage quotas, and/or settlement restrictions. The policy enforcement engine 855 may interrupt, revoke, reroute, pause, escalate, and/or terminate autonomous transactions upon detecting policy violations.

In some embodiments, the platform 800 may enforce machine-readable licensing restrictions associated with at least one of digital assets, APIs, datasets, services, computational resources, inference rights, training rights, geographic rights, and temporal access rights. Such enforcement may comprise, for example, validate usage rights, by for example, the rights management engine 865, before fulfillment, enforce geographic licensing restrictions, enforce time-limited access rights, enforce AI-training restrictions, enforce inference-only permissions, dynamically meter licensed usage, and/or generate machine-readable audit logs for rights holders.

In some embodiments, the transaction orchestration engine 810 may, for example, generate dependency graphs, coordinate subtask execution, aggregate partial responses, validate intermediate outputs, recombine results into unified outputs, allocate compensation proportionally, and/or dynamically reroute failed subtasks.

In other embodiments, consumer and/or service agents may be associated with particular identities. In such instances, the identity verification engine 880 may perform identity verification by confirming, for example, cryptographic signatures, certificate validation, delegated authorization, issuer verification, trust registries (also or alternatively may be accessed by the trust engine 850), behavioral reputation analysis, zero-knowledge verification, and/or anonymous trusted credentials. Further, the platform 900 may permit autonomous transactions without transmitting user credentials to trusted or other agents.

In some embodiments, the pricing engine 860 may dynamically determine and/or adjust pricing based on, for example, at least one of the parameters of token consumption, compute utilization, processing latency, model complexity, response confidence, energy consumption, demand conditions, result quality, fulfillment urgency, and resource scarcity. the pricing engine 960 may determine and/or adjust pricing in an intermittent or continuous manner during execution of a transaction.

In some embodiments, the platform 800 utilizes normalized transaction objects representing information of, for example, intent messages, capability advertisements, pricing negotiation objects, settlement events, fulfillment receipts, authorization tokens, rights descriptors, audit and/or records.

The platform may utilize communication between engines 810-840, and with the consumer and service agent using, for example, GraphQL (API standard), gRPC (open-source Remote Procedure Call framework), message queues, event streams, peer-to-peer protocols, blockchain-based messaging, and/or secure enclave communication systems.

It should be readily understood that platform may operate within at least one of a cloud computing environment and distributed autonomous networks.

### Aspects

The following aspects implement one or more aspects of methods and/or systems of the present disclosure. These aspects are non-limiting aspects. Features of different aspects may be combined in other implementations. Features of each aspect may be modified or removed in other implementations.

In one aspect, at least one of the consumer agents or service agents comprises a software module, plugin, mobile application, browser extension, script, or user interface element, configured to perform agent functions autonomously or semi-autonomously on behalf of a human user or system.

In one aspect, payment for a requested product or service comprises one or more of:
(i) digital tokens or cryptocurrency,
(ii) user-provided data including personal, behavioural, or preference information,
(iii) user actions including survey participation or advertisement interactions, or
(iv) non-monetary exchanges such as provision of alternative services.

In one aspect, the method further comprises:
receiving a consumer request generated by a consumer agent,
receiving a service agent response determined via an off-platform matching or negotiation mechanism,
validating the match according to predefined rules or trust indicators, and
facilitating execution of the request via the agent platform, including payment processing or communication enablement.

In one aspect, the consumer agent is trained on a dynamic taxonomy of service categories and utilizes a retrieval-augmented generation (RAG) model to formulate or interpret the consumer request and/or service agent offerings.

In one aspect, a consumer request is fulfilled by a plurality of service agents, and the processing unit is further configured to:
(i) coordinate response aggregation,
(ii) manage partial result validation, and
(iii) distribute payments to respective service agents based on contribution metrics or predefined allocation rules.

In one aspect, the processing unit incorporates regulatory compliance modules including:
(i) know-your-customer (KYC) verification of agents,
(ii) logging mechanisms for tax and financial auditing, and
(iii) enforcement of data privacy regulations such as GDPR or CCPA.

In one aspect, at least one of the consumer agents or service agents comprises a software module, plugin, mobile application, browser extension, script, or user interface element, configured to perform agent functions autonomously or semi-autonomously on behalf of a human user or external system.

In one aspect, the product or service is exchanged for one or more of:
(i) digital tokens or cryptocurrency;
(ii) user-provided data including personal, behavioral, or demographic information;
(iii) user actions comprising survey participation, advertisement interaction, or content contribution; or
(iv) provision of alternate services in a barter-like exchange.

In one aspect, a method comprises:
receiving a consumer request from a consumer agent;
receiving a service agent response, wherein the service agent was identified or matched to the consumer request by an off-platform discovery or negotiation process;
validating the proposed match according to predefined trust parameters or interaction history; and
executing the matched request through the platform, including managing communication and settlement between the matched parties.

In one aspect, the consumer agent is trained on a dynamically generated or updated taxonomy of service categories, and utilizes a retrieval-augmented generation (RAG) model to interpret consumer intent or formulate structured requests to service agents.

In one aspect, a consumer request is fulfilled collaboratively by a plurality of service agents and the processing unit is configured to:
(i) distribute the request into subcomponents;
(ii) coordinate partial responses;
(iii) aggregate results into a unified response; and
(iv) allocate payment among the participating service agents based on predefined rules, contribution metrics, or negotiated rates.

In one aspect, the platform further comprises:
(i) a compliance module enforcing data privacy laws including GDPR or CCPA;
(ii) a KYC module for identity verification of agents and users; and
(iii) a transaction logging mechanism suitable for tax, legal, or regulatory audits.

### EXAMPLES

Example 1 is a distributed autonomous transaction platform comprising: at least one processing unit adapted to provide: a transaction orchestration engine configured to generate machine-readable transaction objects representing autonomous commercial intents associated with at least one request by at least one consumer; a routing engine configured to dynamically select among at least one of a plurality of autonomous service agents based on at least one of trust scores, pricing conditions, computational efficiency, and policy constraints, and route the machine-readable transaction objects via a communication interface to the selected at least one of a plurality of autonomous service agents in connection with fulfillment of a particular request by a particular consumer; a settlement engine configured to aggregate a plurality of autonomous transactions into deferred settlement groups based on responses from the selected at least one of a plurality of autonomous service agents for fulfillment of the request by the particular consumer; and a fulfillment verification engine configured to validate execution results from the service agents associated with the plurality of autonomous transactions in the deferred settlement groups prior to settlement authorization.

Example 2 is the platform of example 1, wherein the processing unit is adapted to determine a trust score associated with at least one consumer agent or service agent based on historical transaction behavior, fulfillment reliability, settlement history, transaction dispute frequency, fulfillment verification results, behavioral anomaly detection, organizational affiliation, cryptographic identity verification, delegated authorization status and policy compliance history.

Example 3 is the platform of example 1 wherein the processing unit is adapted to receive from the at least one of a plurality of autonomous service agents a machine-readable capability descriptor indicative of at least one of pricing parameters, service availability, licensing restrictions, and trust indicators.

Example 4 is the platform of example 1, wherein settlement is deferred until at least one of a predefined monetary threshold, usage threshold, and time interval, is reached.

Example 5 is the platform of example 1, wherein the processing unit enforces transaction policies including spending limits, jurisdiction restrictions, approval workflows, or compliance requirements.

Example 6 is the platform of example 1, wherein fulfillment is verified using at least one of cryptographic verification, execution receipt validation, output hashing, proof-of-computation verification, challenge-response verification, timestamp validation, usage attestation, and distributed consensus validation.

Example 7 is the platform of example 1, wherein pricing is dynamically adjusted based on computational resources consumed during fulfillment.

Example 8 is the platform of example 1, wherein the processing unit validates machine-readable licensing restrictions prior to permitting access to a digital asset or service.

Example 9 is the platform of example 1, wherein the processing unit selects among multiple service agents based on pricing, latency, trust score, or computational efficiency.

Example 10 is the platform of example 1, wherein the autonomous transactions are executed using trusted agent credentials without transmitting credentials to such agents.

Example 11 is the platform of example 1, wherein the platform aggregates multiple autonomous transactions into deferred settlement groups.

Example 12 is the platform of example 11, wherein the settlement occurs upon reaching a monetary threshold, usage threshold, time interval, or fulfillment verification condition.

Example 13 is the platform of example 1, wherein the processing unit selects from a plurality of multiple service agents based on pricing, latency, trust score, computational efficiency, or fulfillment history.

Example 14 is the platform of example 1, wherein the processing unit processes a consumer request into multiple subcomponents executed by multiple service agents.

Example 15 is the platform of example 14, wherein the processing unit aggregates partial responses generated by the multiple service agents into a unified response.

Example 16 is the platform of example 1, wherein the platform enforces machine-readable licensing restrictions associated with at least one of digital assets, APIs, datasets, computational resource, inference rights, training rights, geographic rights, and temporal access rights.

Example 17 is the platform of example 1, wherein the platform permits autonomous transactions without transmitting user credentials to service agents.

Example 18 is the platform of example 1, wherein the platform enforces one or more dynamic policies including spending limits, jurisdiction restrictions, approval workflows, or compliance requirements.

Example 19 is the platform of example 1, wherein the platform generates immutable transaction logs representing fulfillment status, settlement states, policy decisions, or licensing validations.

Example 20 is the platform of example 1, wherein the platform dynamically recalculates routing decisions during transaction execution based on changing pricing conditions, service availability, or policy constraints.

Example 21 is the platform of example 1, wherein the platform generates machine-readable transaction objects representing at least one of commercial intents, service capabilities, settlement terms, and fulfillment conditions.

Example 22 is the platform of example 1, wherein the processing unit is configured to generate a machine-readable transaction object representing at least one of a consumer intent, one or more requested services, one or more pricing constraints, one or more settlement parameters, one or more trust requirements, and one or more fulfillment conditions.

Example 23 is the platform of example 22, wherein the machine-readable transaction object further representing at least one of authorization credentials, geographic restrictions, privacy requirements, computational constraints, service quality requirements, latency thresholds, expiration parameters, and licensing restrictions.

Example 24 is the platform of example 1, wherein the processing unit is configured to negotiate executable transaction parameters between a consumer agent and a service agent based on at least one of pricing conditions, service availability, trust indicators, licensing permissions, computational resource availability, fulfillment confidence scores, historical transaction behavior, and policy constraints.

Example 25 is the platform of example 24, wherein the executable transaction parameters are negotiated autonomously without direct human intervention.

Example 26 is the platform of example 1, wherein the processing unit modifies at least one of transaction permissions, settlement timing, pricing, routing decisions, access rights, and authorization thresholds based on at least one trust score.

Example 27 is the platform of example 1, wherein the platform aggregates multiple autonomous transactions into deferred settlement groups associated with at least one of, a user, a consumer agent, a service agent, an organization, an enterprise account, a workflow, a session, and a persistent machine identity.

Example 27 is the platform of example 1, wherein the platform aggregates multiple autonomous transactions into deferred settlement groups associated with at least one of, a user, a consumer agent, a service agent, an organization, an enterprise account, a workflow, a session, and a persistent machine identity.

Example 28 is the platform of example 27, wherein settlement is triggered upon occurrence of at least one of reaching a monetary threshold, reaching a transaction count threshold, expiration of a predefined time interval, completion of a workflow, fulfillment verification, and policy approval, trust validation, and completion of a usage aggregation period.

Example 29 is the platform of example 1, wherein the processing unit provisionally authorizes autonomous transactions prior to final settlement.

Example 30 is the platform of example 29, wherein the provisional authorization is based on at least one of trust scores, behavioral history, fraud probability estimation, organizational policy, identity verification, settlement reliability, and delegated authority.

Example 31 is the platform of example 1, wherein the processing unit is configured to process a consumer request into a plurality of subcomponents for execution by multiple service agents.

Example 32 is the platform of example 31, wherein the processing unit generates data indicative of a dependency graph representing execution relationships between the plurality of subcomponents.

Example 33 is the platform of example 31, wherein the processing unit is configured to perform at least one of coordinate subtask execution, validate intermediate outputs, aggregate partial responses, dynamically reroute failed subtasks, and recombine results into a unified response.

Example 34 is the platform of example 1, wherein the processing unit is configured to select among multiple service agents using routing algorithms based on at least one of latency, trust score, computational efficiency, energy efficiency, pricing, historical fulfillment quality, service availability, settlement risk, licensing permissions, geographic proximity, and policy constraints.

Example 35 is the platform of example 34, wherein the routing decisions are recalculated during transaction execution based on changing network conditions or service availability.

Example 36 is the platform of example 6, wherein the fulfillment verification generates machine-verifiable transaction records.

Example 37 is the platform of example 1, wherein the platform is configured to generate immutable transaction logs representing at least one of request parameters, routing decisions, fulfillment status, settlement states, policy decisions, licensing validations, audit events, and verification results.

Example 38 is the platform of example 16, wherein the processing unit dynamically meters licensed usage of machine-consumable resources.

Example 39 is the platform of example 16, wherein the processing unit is configured to perform at least one of pause, revoke, reroutes, escalates, restricts, and terminate, an autonomous transaction upon detection of at least one of a licensing violation and policy violation.

Example 40 is the platform of example 1, wherein the pricing is determined based on at least one of token consumption, compute utilization, memory utilization, response latency, response confidence, energy consumption, resource scarcity, urgency indicators, bandwidth utilization, and output quality metrics.

Example 41 is the platform of example 40, wherein the pricing is recalculated during execution of a transaction.

Example 42 is the platform of example 1, wherein the processing unit enforces dynamic policies including at least one of spending limits, rate limits, jurisdiction restrictions, approval workflows, vendor allowlists, vendor blocklists, privacy requirements, compliance requirements, content restrictions, settlement restrictions, and escalation thresholds.

Example 43 is the platform of example 1, wherein the platform associates autonomous service agents with durable machine identities.

Example 44 is the platform of example 43, wherein the identity verification comprises at least one of cryptographic signatures, certificate validation, delegated authorization, issuer verification, trust registry validation, anonymous trusted credentials, and zero-knowledge verification.

Example 45 is the platform of example 1, wherein the communication interface is configured to support at least one of REST protocols, GraphQL protocols, gRPC protocols, event streaming systems, distributed queues, peer-to-peer communication protocols, blockchain messaging systems, and secure enclave communication systems.

Example 46 is the platform of example 1, wherein the platform operates within at least one of a cloud computing environment and distributed autonomous networks.

Example 47 is the platform of example 1, wherein the processing unit generates machine-readable agreements executable for execution by respective ones of the consumer agents and service agents.

Example 48 is the platform of example 47, wherein the machine-readable agreements define at least one of pricing parameters, fulfillment conditions, settlement timing, trust requirements, usage restriction, licensing conditions, and verification requirements.

### LIST OF REFERENCES

110 Initiating a task using an artificial agent, such as a Computer Using Agent
120 The agent accessing a web page or application with paywalled content
130 Providing a paywall with option for deferred payment
140 Accessing content using deferred payment
150 The agent using the content to complete the task
200 A system according to the invention
210 User device, such as a computer or mobile device
220 Artificial agent, such as a Computer Using Agent
230 Entity, such as a web page or application with paywalled content
240 Payment server
250 agent provider
410 Requesting shared secret
420 Establish shared secret between the agent and the payment server
430 Sending token to payment server for validation
440 Responding with validation of token
510 Sending context for inference to agent provider, including token
520 Responding with action, including signed token
530 Requesting validation of signature
540 Responding to request for validation
600 agent platform
610 processing unit
620 communication interface
630 database
640 consumer agents
650 service agents
700 Mediator
705 Negotiate a price for services
715 identifies services based on known capabilities (+further filtering)
725 Agree on a price, exchange data/results
735 verify outcomes
740 Consumer Request
750 Services
751 Chosen Service 1
752 Chosen Service 2
800 transaction platform
810 transaction orchestration engine
820 routing engine
830 settlement engine
840 fulfilment verification engine
850 trust engine
855 policy enforcement engine
860 pricing engine
865 rights management engine
870 transaction aggregation engine
875 compliance engine
880 identity verification engine
885 communication channels

It is to be understood that the invention is not limited to the particular embodiments of the invention described above, as variations of the particular embodiments may be made and still fall within the scope of the appended claims.

We claim:

1. A distributed autonomous transaction platform comprising:
at least one processing unit adapted to provide:
a transaction orchestration engine configured to generate machine-readable transaction objects representing autonomous commercial intents associated with at least one request by at least one consumer;
a routing engine configured to dynamically select among at least one of a plurality of autonomous service agents based on at least one of trust scores, pricing conditions, computational efficiency, and policy constraints, and route the machine-readable transaction objects to the selected at least one of a plurality of autonomous service agents in connection with fulfillment of a particular request by a particular consumer;
a settlement engine configured to aggregate a plurality of autonomous transactions into deferred settlement groups based on responses from the selected at least one of a plurality of autonomous service agents for fulfillment of the request by the particular consumer; and
a fulfillment verification engine configured to validate execution results from the service agents associated with the plurality of autonomous transactions in the deferred settlement groups prior to settlement authorization.

2. The platform of claim 1, wherein the processing unit is adapted to determine a trust score associated with at least one consumer agent or service agent based on historical transaction behavior, fulfillment reliability, settlement history, transaction dispute frequency, fulfillment verification results, behavioral anomaly detection, organizational affiliation, cryptographic identity verification, delegated authorization status and policy compliance history.

3. The platform of claim 1, wherein the processing unit is adapted to receive from the at least one of a plurality of autonomous service agents a machine-readable capability descriptor indicative of at least one of pricing parameters, service availability, licensing restrictions, and trust indicators.

4. The platform of claim 1, wherein settlement is deferred until at least one of a predefined monetary threshold, usage threshold, and time interval, is reached.

5. The platform of claim 1, wherein the processing unit enforces transaction policies including spending limits, jurisdiction restrictions, approval workflows, or compliance requirements.

6. The platform of claim 1, wherein fulfillment is verified using at least one of cryptographic verification, execution receipt validation, output hashing, proof-of-computation verification, challenge-response verification, timestamp validation, usage attestation, and distributed consensus validation.

7. The platform of claim 1, wherein pricing is dynamically adjusted based on computational resources consumed during fulfillment.

8. The platform of claim 1, wherein the processing unit validates machine-readable licensing restrictions prior to permitting access to a digital asset or service.

9. The platform of claim 1, wherein the processing unit selects among multiple service agents based on pricing, latency, trust score, or computational efficiency.

10. The platform of claim 1, wherein the autonomous transactions are executed using trusted agent credentials without transmitting credentials to such agents.

11. The platform according to claim 1, wherein the platform aggregates multiple autonomous transactions into deferred settlement groups.

12. The platform according to claim 11, wherein settlement occurs upon reaching a monetary threshold, usage threshold, time interval, or fulfillment verification condition.

13. The platform according to claim 1, wherein the processing unit selects from a plurality of multiple service agents based on pricing, latency, trust score, computational efficiency, or fulfillment history.

14. The platform according to claim 1, wherein the processing unit processes a consumer request into multiple subcomponents executed by multiple service agents.

15. The platform according to claim 14, wherein the processing unit aggregates partial responses generated by the multiple service agents into a unified response.

16. The platform according to claim 1, wherein the platform enforces machine-readable licensing restrictions associated with at least one of digital assets, APIs, datasets, computational resource, inference rights, training rights, geographic rights, and temporal access rights.

17. The platform according to claim 1, wherein the platform permits autonomous transactions without transmitting user credentials to service agents.

18. The platform according to claim 1, wherein the platform enforces one or more dynamic policies including spending limits, jurisdiction restrictions, approval workflows, or compliance requirements.

19. The platform according to claim 1, wherein the platform generates immutable transaction logs representing fulfillment status, settlement states, policy decisions, or licensing validations.

20. The platform according to claim 1, wherein the platform dynamically recalculates routing decisions during transaction execution based on changing pricing conditions, service availability, or policy constraints.

21. The platform according to claim 1, wherein the platform generates machine-readable transaction objects representing at least one of commercial intents, service capabilities, settlement terms, and fulfillment conditions.

22. The platform according to claim 1, wherein the processing unit is configured to generate a machine-readable transaction object representing at least one of a consumer intent, one or more requested services, one or more pricing constraints, one or more settlement parameters, one or more trust requirements, and one or more fulfillment conditions.

23. The platform according to claim 22, wherein the machine-readable transaction object further representing at least one of authorization credentials, geographic restrictions, privacy requirements, computational constraints, service quality requirements, latency thresholds, expiration parameters, and licensing restrictions.

24. The platform according to claim 1, wherein the processing unit is configured to negotiate executable transaction parameters between a consumer agent and a service agent based on at least one of pricing conditions, service availability, trust indicators, licensing permissions, computational resource availability, fulfillment confidence scores, historical transaction behavior, and policy constraints.

25. The platform according to claim 24, wherein the executable transaction parameters are negotiated autonomously without direct human intervention.

26. The platform according to claim 1, wherein the processing unit modifies at least one of transaction permissions, settlement timing, pricing, routing decisions, access rights, and authorization thresholds based on at least one trust score.

27. The platform according to claim 1, wherein the platform aggregates multiple autonomous transactions into deferred settlement groups associated with at least one of, a user, a consumer agent, a service agent, an organization, an enterprise account, a workflow, a session, and a persistent machine identity.

28. The platform according to claim 27, wherein settlement is triggered upon occurrence of at least one of reaching a monetary threshold, reaching a transaction count threshold, expiration of a predefined time interval, completion of a workflow, fulfillment verification, and policy approval, trust validation, and completion of a usage aggregation period.
